(19) United States
(12) Patent Application Publication
(10) Pub. No.: US 2005/0026031 A1
(43) Pub. Date: Feb. 3, 2005

(54) Nickel-plated screen for electrochemical cell

(76) Inventors: Rodney S. McKenzie, Madison, WI (US); Jeremy Chapman, Portage, WI (US); Zhihong Jin, Cottage Grove, WI (US); Joseph L. Passaniti, Madison, WI (US); Jeffrey A. Poirier, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 10/633,152

(22) Filed: Aug. 1, 2003

(51) Int. Cl. H01M 4/86; H01M 12/06; H01M 4/88

(52) U.S. Cl. 429/44; 429/27; 502/101; 29/623.2

(57) ABSTRACT

A screen for an electrochemical cell is fabricated by providing an interwoven wire mesh, and electroplating nickel onto the mesh, which bonds with the joints to create a screen usable with an electrochemical cell. The mesh can first be rolled to partially bond the wires prior to the electroplating step.

### CROSS-REFERENCE TO RELATED APPLICATIONS

### STATEMENT REGARDING FEDERALLY SPONSORED RESEARCH OR DEVELOPMENT

### BACKGROUND OF THE INVENTION

The present invention relates generally to electrochemical cells, and in particular relates to metal-air cells of the zinc-air type having improved strength characteristics.

Metal-air cells are used for a variety of applications. A large fraction of such cells are used in hearing aids. Newer versions of such hearing aids are placed inside the outer portion of the human ear, whereby any leakage of material from the cell can come into contact with the skin of the wearer, in the wearer's ear. It is thus important, as with electrochemical cells in general, to provide an adequate seal to prevent active cell material from leaking while maximizing the internal cell volume that can be occupied by active cell material.

Conventional metal-air cells include an open anode can containing a mixture of anode and electrolyte. The anode can is closed by a cathode can including a cathode assembly made of cathode mixture that is pressed against a woven nickel screen that provides a positive current collector for the cell. In particular, a plurality of interwoven fine nickel wires (mesh) are bonded together to form the screen, and polytetrafluoroethylene (PTFE), commercially known as Teflon®, is mixed with carbon to form a paste that is applied to the anode-facing outer surface of the mesh. Teflon provides a wet-proofing agent which prevents the cathode from becoming flooded with electrolyte from the anode. The carbon provides a catalyst for the cathodic reaction that takes place during operation of the cell. A sufficient quantity of carbon is present in the paste to render the coating, and thus the coated screen, conductive as is well known in the art. Maintaining physical and electrical contact between the paste and the screen is desired and necessary for device function.

A mechanically bonded wire screen is conventionally fabricated using a rolling procedure. In particular, a wire mesh having non-bonded longitudinal and lateral interwoven nickel wires is rolled to bond the wires together, and then annealed to increase the cross-wirebond strength and reduce the work-hardening of the mesh. The wire mesh can be rolled a second time to complete the bonding, and again annealed to reduce the work-hardening from the second rolling step.

Unfortunately, fabricating a mechanically bonded wire screen is time consuming and expensive. Furthermore, each rolling step tends to flatten the wires at their intersections. FIG. 1A schematically illustrates a portion of a wire mesh structure 15 having a laterally extending wire 17 that is intersected by a pair of longitudinally extending wires 19. Before rolling, the mesh has an initial height H₁ generally equal to the diameter (or thickness) of the overlapping diameters of the lateral and longitudinal wires 17 and 19. Referring to FIG. 1B, after the structure is rolled to bond the mesh 15, each wire becomes flattened, thereby reducing the mesh 15 to a height H₂ that is less than initial height H₁. The reduction in height correspondingly reduces the structural integrity of the mesh 15.

As a result, during final assembly of the cell, bi-axial pressure exerted by the distal edge of the anode can assembly (or seal foot) against the cathode assembly when the cell is crimped causes the mesh 15 to rise toward the top wall of the anode can (a phenomenon known as doming), and thus to partially withdraw from its location adjacent the bottom wall of the cathode can. Doming is a secondary outcome of compression of the cathode assembly which is desirable to form an adequate seal between the cathode assembly and the cathode can. Doming also helps maintain anode-to-cathode contact and provides air access space to the cathode. As the anode volume increases with the progression of discharge, while the specific volume of the anode active material increases with oxidation, the cathode is pushed back toward the cathode can, thus utilizing the available volume.

Thus, while some degree of doming is desired, the negative effect of partial loss of screen-to-cathode can electrical contact is not, and this behavior limits the ability to compress the cathode and form a tight seal at the interface between the cathode assembly and the cathode can. Accordingly, it is desirable to eliminate doming to the greatest extent possible while maintaining an adequate seal between the cathode assembly and the side wall of the cathode can when the cell is crimped. Unfortunately, a mechanically bonded (and thus flat) wire mesh contributes to excessive doming when the cell is closed.

What is therefore desirable is to provide a method of fabricating a wire screen usable in a metal-air electrochemical cell that has improved structural integrity compared to conventional screens to resist doming and to improve its ability to hold and make electrical contact to the carbon and Teflon-based paste.

### BRIEF SUMMARY OF THE INVENTION

The present invention recognizes that wires of a mesh can be bonded to produce a screen for an electrochemical cell having increased strength characteristics.

In one aspect, a cathode assembly is provided for a metal-air cell. The assembly includes an air diffusion layer operable to receive air and deliver the received air to the cathode assembly. An active layer includes longitudinally extending electrically conducting wires interwoven with laterally extending electrically conducting wires that intersect at joints to form a mesh. A metal is deposited onto the wires that bonds the longitudinally extending wires to the laterally extending wires at the joints to form a screen.

In another aspect of the invention, the metal is electroplated onto the wires.

In another aspect of the invention, the mesh can be pressure-bonded prior to the electroplating.

In another aspect, methods for producing the cathode assembly are provided.

In another aspect, electrochemical cells incorporating the screen along with methods for fabricating such electrochemical cells are provided.

These and other aspects of the invention are not intended to define the scope of the invention for which purpose claims are provided. In the following description, reference is made to the accompanying drawings, which form a part hereof, and in which there is shown by way of illustration, and not limitation, a preferred embodiment of the invention. Such embodiment does not define the scope of the invention and reference must be made therefore to the claims for this purpose.

### BRIEF DESCRIPTION OF THE SEVERAL VIEWS OF THE DRAWINGS

The following figures are presented, in which like reference numerals correspond to like elements throughout, and in which:

FIG. 1A is a schematic side elevation view of interwoven wires for a cathode screen of a metal-air cell that have not yet been bonded together;

FIG. 1B is a schematic side elevation view of the wires illustrated in FIG. 1 after a series of rolling steps have been performed to bond the wires together;

FIG. 2 is a schematic sectional side elevation view of an electrochemical cell constructed in accordance with the preferred embodiment of the invention

FIG. 3 is an enlarged sectional side elevation view of the cathode assembly illustrated in FIG. 2;

FIG. 4 is a schematic view of an electroplating system used in accordance with the preferred embodiment;

FIG. 5 is a perspective view of an electroplated nickel screen constructed in accordance with the preferred embodiment;

FIG. 6 is an enlarged perspective view of a nickel-plated wire illustrated in FIG. 5;

FIG. 7A is a sectional side elevation view of an electroplated screen joint illustrated in FIG. 5;

FIG. 7B is a schematic top plan view of the wires of the type illustrated in FIG. 1A after a metal deposition process has been carried out to bond the wires;

FIG. 8 is a flowchart illustrating a method to construct an electrochemical screen in accordance with an alternate embodiment of the invention;

FIG. 9 is a cross-section of a can-less metal-air cell constructed in accordance with an alternate embodiment of the invention;

FIG. 10 is a fragmentary enlarged cross-sectional view of the cell illustrated in FIG. 9 showing top and bottom portions of the cell; and

FIG. 11 is a cross-sectional view of a cell similar to that illustrated in FIG. 10 but with the cathode assembly constructed in accordance with an alternate embodiment.

### DETAILED DESCRIPTION OF THE INVENTION

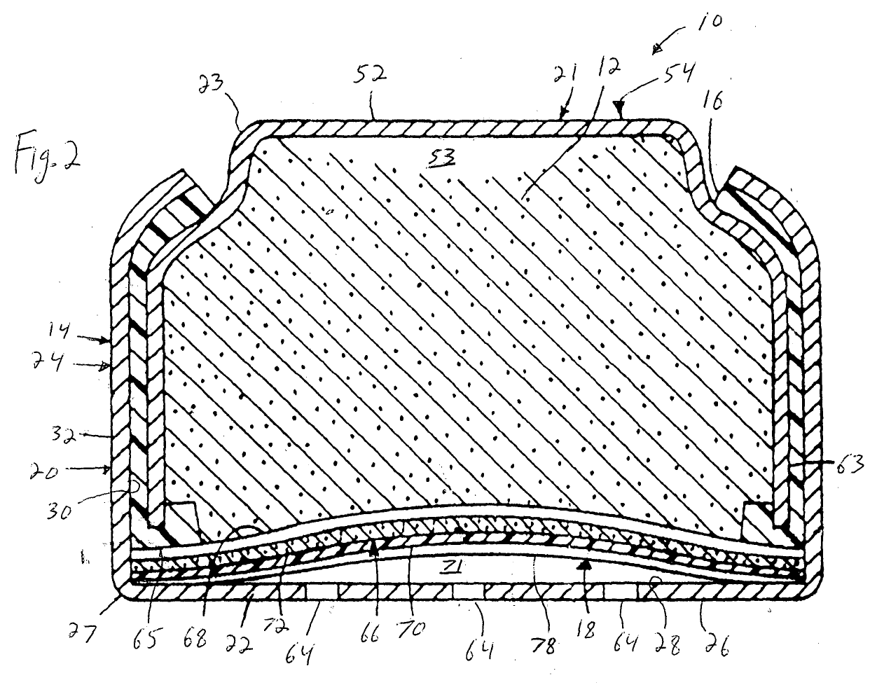

Referring to FIG. 2, a metal-air cell, and in particular a button cell 10, is in the form of a zinc-air cell, though it should be appreciated that any suitable metal-air cell can be used in accordance with the present invention. The negative electrode 21 of the cell 10, commonly referred to as the anode, includes an anode can 54 that contains anode material 12, which includes a mixture of materials such as zinc and an alkaline electrolyte. In accordance with the preferred embodiment, the anode can material comprises stainless steel, with a layer of metal (preferably nickel) clad on the outer surface, and a layer of copper clad on the inner surface, though it should be easily understood by one having ordinary skill in the art that any well known anode container material could be used with an electrochemically compatible inner surface in contact with the anode material. The anode can 54 has a generally circular top wall 52 and an annular side wall 63 that extends outwardly and downwardly from the outer perimeter 23 of the top wall 52. The interior of can 54 defines an open cavity 53 that contains the anode mixture 12.

The cell 10 further includes a positive electrode 14, commonly referred to as the cathode. Cathode 14 includes a cathode assembly 18 contained within a cathode can 20 that encloses cavity 53. Cathode can 20 includes a generally cylindrical bottom 22, and annular upstanding side wall 24 extending upwardly from the bottom 22 at its outer perimeter 27. Side wall 24 presents an annular inner surface 30 and outer surface 32 that extend about the circumference of the cathode can 20. Bottom 22 has a generally flat inner surface 28 and a generally flat outer surface 26. One or more air ports 64 extends through the bottom 22 of the cathode can 20 to provide avenues for air to flow into the cathode assembly 18.

The anode can 54 is electrically insulated from the cathode can 20 via a seal 13, that includes an annular side portion 16 disposed between the upstanding side wall 24 of the cathode can 20 and the downwardly-depending side wall 63 of the anode can 54. A seal foot 65 is disposed at the lower end of side wall 16. The distal end of side wall 63 is embedded in the seal to prevent leakage of anode and electrolyte during use. Seal 13 comprises nylon 6,6 in accordance with the preferred embodiment, but could alternatively comprise other suitable materials that are capable of providing the requisite insulation as well as sealing. Examples of such alternative materials include high temperature polypropylenes, such as the type commercially available from Basell USA, Inc., located in Wilmington, Del., that include nucleated, high meltflow, impact modified polypropylene copolymer and a polypropylene homopolymer resin.

The cathode assembly 18 is spaced from the bottom 22 by an air reservoir 71. Air entering the cell 10 accesses air reservoir 71 via air ports 64. A first air diffusion layer 78 defines the upper boundary for the air reservoir 71. Layer 78 preferably comprises Teflon, and is sufficiently porous to direct the air disposed in reservoir 71 upwardly towards the active cathode components. A second air diffusing layer 70 is disposed above and adjacent layer 78, and can comprise a nonwoven material that enables sufficient air diffusion for cell function, while having sufficient strength to support the cathode assembly 18 and preventing the air reservoir 71 from becoming overly compressed. Alternatively, layer 70 can comprise Teflon. The porosity of layer 70 is reduced compared to layer 78 to increase the diffusion of air entering the active cathode components. It should further be appreciated that diffusion layer 78 may be eliminated, such that cell 10 includes only one air diffusion layer. Alternatively still, it should be appreciated that an air mover (not shown) could be installed in cell 10 to assist in air circulation.

Referring now also to FIG. 3, the cathode assembly 18 includes an active cathode layer 66 that is disposed above diffusion layer 70. Active layer 66 preferably includes a carbon catalyst 74 that is pressed onto the cathode-facing surface of a woven nickel-plated screen 72. Catalyst 74 preferably comprises a mixture of carbon and PTFE. It should be appreciated that a portion of the mixture 74 bleeds through the screen 72 when compressed. Mixture 74 facilitates the reaction between the hydroxyl in the electrolyte and the cathodic oxygen of the air. Wires are preferably formed from nickel, and alternatively from any transition metal or combination of metals which can be formed into wires and which are effectively stable at the corresponding electrode potentials, for example titanium and stainless steel.

Separator layer 68 is disposed above active layer 66 at the interface between the anode 21 and cathode assembly 18, and is preferably adhesively attached to the cathode 14. Separator 68 permits electrolyte transfer between the anode 21 and cathode 14 while providing ionic conductivity and electrical isolation therebetween. Separator 68 has sufficient porosity to enable permeability to liquid such as an electrolyte, but is substantially solid so as to physically prevent the cathode from electronically shorting with the anode. Separator 68 can comprise one or more layers of a non-woven, inert fabric or a permanently wettable microporous membrane. Alternatively, the separator 68 can comprise a conformal separator formed from a polymer and an inorganic cross-linking agent that occupies significantly less volume than a conventional fabric, thereby providing greater volume for active material. The conformal separator may be applied directly to the cathode, or alternatively may coat a non-woven, inert fabric. The separator 68 may alternatively comprise a microporous film or a non-woven material coated with a microporous film.

As described above, the present invention avoids the disadvantages associated with fabricating a rolled screen. In particular, screen 72 is fabricated by plating nickel onto wires 73 and 75 either electrolytically, using an electroless process, or by any alternative suitable deposition process to bond the wires together, appreciated by a skilled artisan. Electroplating involves the deposition of a metallic coating onto an object by applying a negative charge onto the object and immersing it into a solution which contains a salt of the metal to be deposited. The metallic ions of the salt carry a positive charge and are thus attracted to and bond to the object. The object may be stationary or passed continuously through the plating process. The plating process may thus be carried out in one or more steps.

In accordance with the preferred embodiment, and with particular reference to FIG. 4, a bath 100 including nickel chloride (NiCl₂), nickel sulfate (NiSO₄), nickel sulfamate, nickel fluoborate, or any alternative solution containing a salt of the metal to be deposited (nickel in accordance with the preferred embodiment) is provided. A current source 102, which could include a traditional battery, rectified current source, or any other alternative current source suitable for electroplating is provided. A woven nickel mesh 104 is immersed in the bath 100 and electrically connected to the negative terminal of the current source 102 via wire 106. A mass 108 of the metal to be plated (nickel in accordance with the preferred embodiment) is also immersed in the bath 100 and electrically connected to the positive terminal of the current source 102 via wire 110. If nickel chloride is used for the bath 100, the nickel salt ionizes in water to Ni⁺⁺ and two parts of Cl⁻. The mesh 104 becomes negatively charged, and attracts the positively charged nickel such that the nickel bonds to wires 73 and 75 as electrons flow from the mesh to the nickel. In accordance with the preferred embodiment, a sheet of woven wire mesh is electroplated, and subsequently cut into individual screens appropriately sized for insertion into electrochemical cell 10.

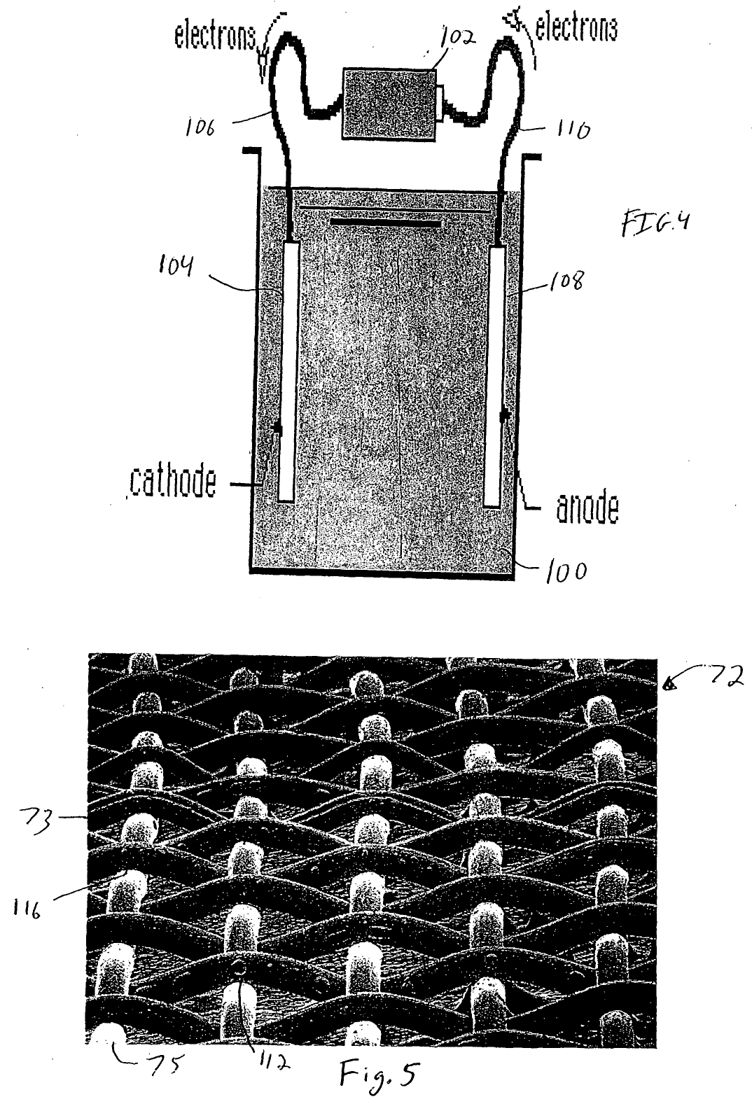

As described above, any type of deposition process sufficient to bond the wires is desired. A rough topography of the plated surface is preferred and is achieved by providing a bath that is preferably devoid of brightening and leveling agents. Referring now to FIGS. 5 and 6, the chemistry of the bath and current density of the current source 102 are predetermined to produce nodules 112 of various sizes that protrude outwardly from the outer surface of wires 73 and 75. The outer surface of the wires 73 and 75 includes a plurality of outwardly extending nodules. The outer surface and nodules 112 are columnar, meaning that the grains 114 of the nickel-plated nodules 112 are substantially parallel to each other and extend substantially normal to, and outwardly from, the outer surface of wires 73 and 75. The columnar nodules 112 achieve a rough topography for wires 73 and 75, thereby increasing the surface area of the screen 72, which provides stronger adherence between the active layer 74 and screen 72 compared to the prior art. Columnar grain diameters in the 1 to 30 μm range with nodules 10 to 100 μm diameter extending outwardly from the surface and occupying from 5 to 50% of the surface are preferred.

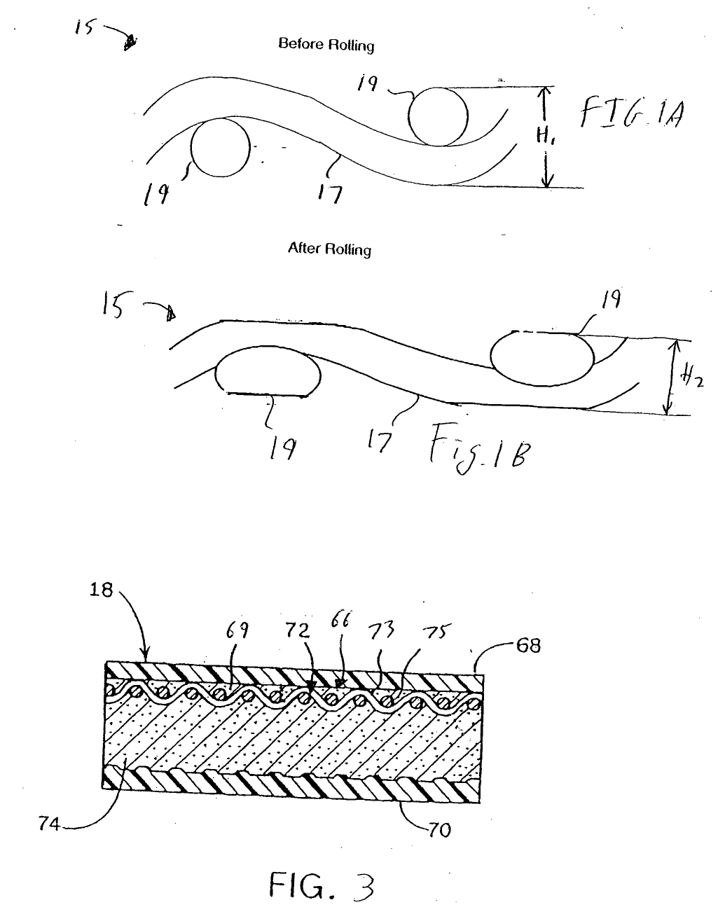

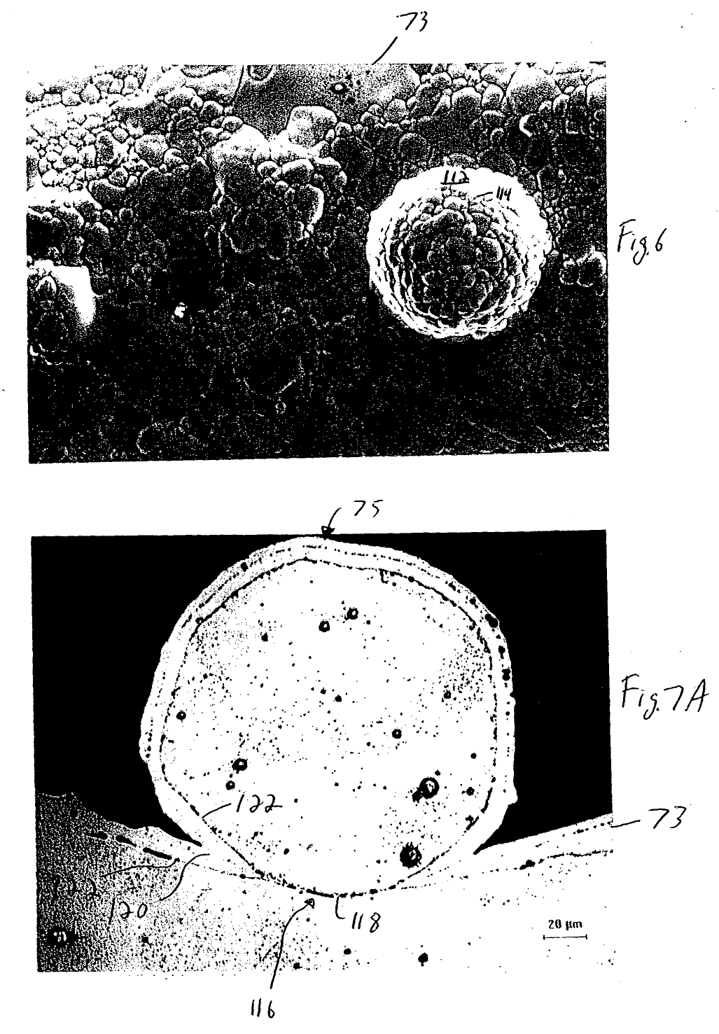

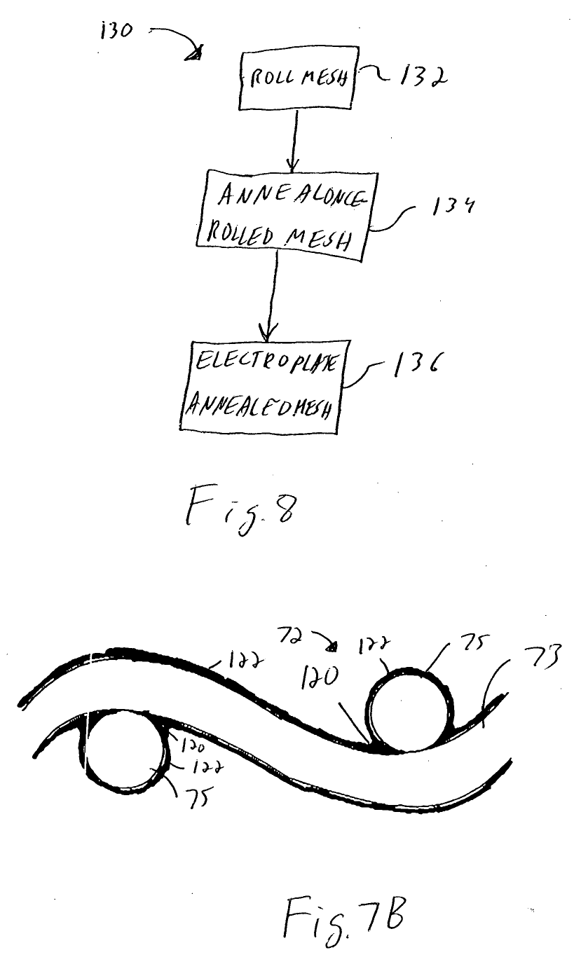

Referring now to FIGS. 7A-B, a joint 116 is formed at the location where a longitudinal wire 73 crosses a lateral wire 75 and contacts wire 75 at location 118. A cleft 120 is produced between wires 73 and 75 adjacent the location of intersection (saddle) 118. After the electroplating process described above is completed, nickel plating 122 adheres to the exposed surfaces of wires 73 and 75, including those surfaces adjoining with cleft 120. As plating 122 accumulates on wires 73 and 75, a substantial portion of cleft 120 becomes occupied with the plating to provide structural integrity to the joint 116 and prevent relative slippage between wires 73 and 75. Each joint of screen 72 is plated as described with reference to joint 116. As a result, the wires are bonded to one another as a single metallurgical unit providing electrical contact and preventing cut ends from separating from the mesh. The resulting wiremesh has a three dimensional structure with a height greater than the height H1 of FIG. 1A. The present invention thus has the advantage of providing a truss network of wires which is more capable of resisting deflection and of bonding with the carbon/Teflon mix than a flattened, mechanically-bonded wiremesh.

Once fabrication of the screen 72 has been completed, a mixture of carbon and PTFE can be pressed against the screen, and the screen can be installed in the cathode assembly 18. The wires 73 and 75 are thus bonded together in accordance with the present invention without flattening the structure of screen 72. In fact, plating thickness increases the total height of screen 72 relative to the cumulative diameters of wires 73 and 75. The nickel plating 122 additionally reinforces the bi-axial strength of the screen 72 such that when the cell 10 is closed during fabrication, the bi-axial forces associated with crimping are resisted by the nickel-plated screen 72 while preventing the screen 72 from bending towards the anode can 54. Furthermore, the increased radial strength of the screen 72 enables the formation of a tighter seal at the periphery of the screen compared to prior art, thereby reducing or eliminating altogether leakage of electrolyte from the anode into the cathode. Such features as described as benefits of the present invention are also desired in other electrochemical cell configurations, for example in cylindrical metal-air batteries or other battery chemistries where compression of an active electrode (cathode) is desirable to provide a seal preventing electrolyte leakage from the cell and/or an electrical connection.

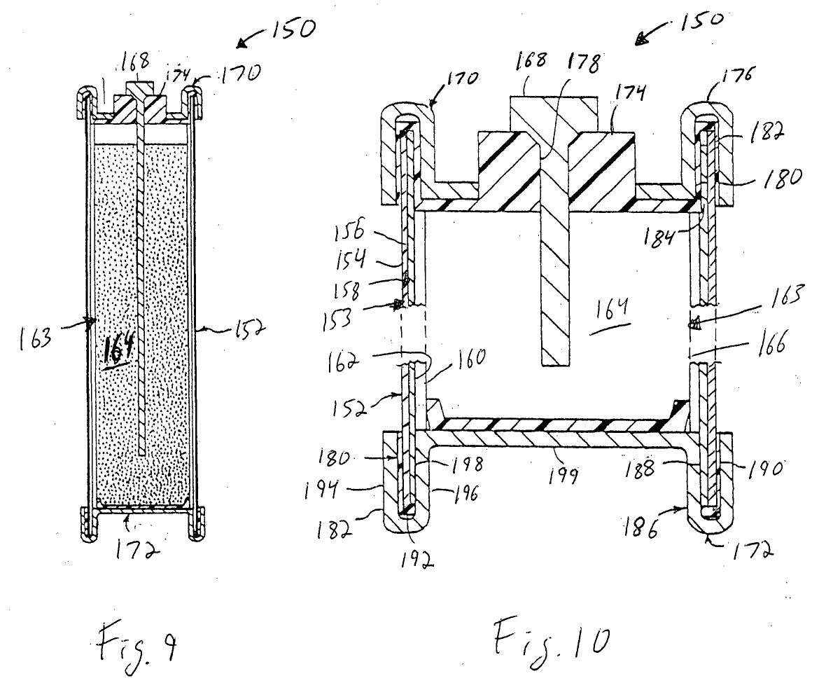

Referring now to FIG. 8, the present invention recognizes that the disadvantages associated with producing a bonded mesh by rolling can be avoided by only partially rolling the mesh in combination with additional bonding steps. In particular, a method 130 for producing screen 72 in accordance with an alternate embodiment of the invention generally includes rolling a wire mesh and subsequently electroplating the once-rolled mesh to form screen 72. The rolling step 132 is accomplished using a rolling instrument that is applied to controlled thickness, for example to a distance between H1 and H2 illustrated in FIGS. 1A and 1B. The rolled mesh is partially flattened at the intersections of wires 73 and 75, which is sufficient to only partially pressure-bond the wires. The partial bond is sufficiently strong to enable the wires to be held together when being passed through either an electroplating process.

Next, at step 134, stresses accumulated within the mesh during the rolling step are removed by annealing the mesh in a reducing atmosphere. In particular, as is well known in the art, the mesh is placed in or passed through an oven and reaches a proper annealing point temperature that allows stresses to be relieved without distorting the wires 73 and 75. Annealing temperatures are in the 800 to 1000° C. range. The oxygen content of the reducing atmosphere is maintained sufficiently low during the annealing process, as is well known in the art. Finally, at step 136, the partially bonded mesh is electroplated in the manner discussed above with reference to FIG. 4. It should be appreciated that the annealing step 134 is optional, and that the partially pressure-bonded mesh may be electroplated without first being annealed.

Advantageously, because the single rolling step 132 does not completely bond the wires 73 and 75, the reduction in mesh height is less than the, height reduction associated with the double-rolling process discussed above. The columnar nodules 112 that protrude outwardly from the outer surface of the wires also add to the surface area of the mesh, as described above. Additionally, the nickel plating reinforces the strength of the single-rolled screen 72 to further resist doming when the cell 10 is closed. Method 130 thus provides an additional alternative to screen production while avoiding the disadvantages associated with double-rolling a wire mesh. One skilled in the art will appreciate that the order of the electroplating and rolling processes could be reversed.

While the invention has been described in combination with metal-air button cells, it should be appreciated that the present invention can be applicable to many electrochemical cell types. The screen 72 of present invention is particularly advantageous when installed into an electrochemical cell whose cathode assembly undergoes compression to achieve a seal during cell closure that prevents leakage. The cell can either be a button cell, as described above, or a cylindrical cell, as will now be described.

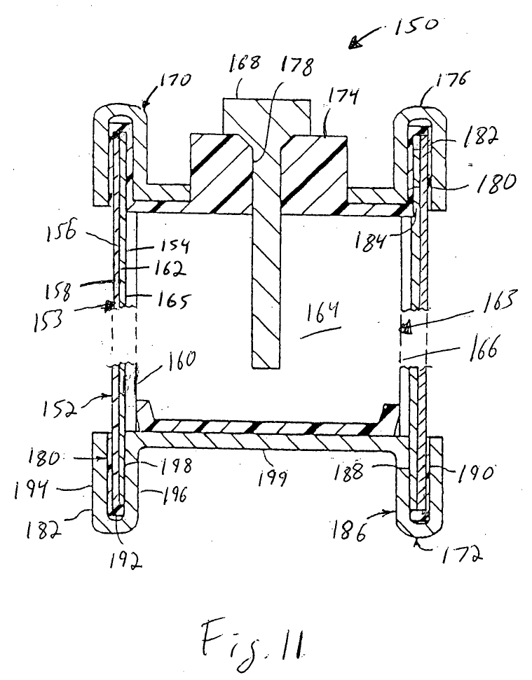

Referring now to FIGS. 9 and 10, a cylindrical metal-air cell 150 (preferably a zinc-air cell) is illustrated having a cylindrical cathode assembly 152 including an active carbon catalyst 154 applied to an outer surface 156 of a nickel-plated screen 158. Screen 158 may be constructed in accordance with any of the embodiments described above. However, instead of being die-cut to a generally circular shape fit to be installed in button cell 10, screen is cut into a rectangular shape. The rectangular screen is then coated with the active carbon catalyst, which includes a mixture of carbon and PTFE as described above, to form an active cathode layer 153. The rectangular coated screen 158 is then manipulated into an annulus such that catalyst 154 is disposed on the radial outer surface 156. Catalyst layer 154 thus defines the radial outer periphery of cell 150.

An ionically permeable separator 160 is installed proximal the radially inner surface 162 of screen 158. Separator 160 may be fabricated in accordance with any of the embodiments described above with reference to separator 68. The separator 160 divides cathode assembly 152 from an anode 163 containing active anode material 164 that is disposed in the annular void 166 that defined by cathode assembly 152. The anode material may include zinc that is wetted with an aqueous electrolyte, for example potassium hydroxide. A negative current collector 168, which may be a brass pin or nail, extends into void 166 in contact with the anode material 164.

Cell 150 includes an annular top closure member 170 that receives the top end of cathode assembly 152, while an annular bottom closure member 172 receives the bottom end of cathode assembly 152. Anode current collector 168 is received through top closure member 170 and projects into the anode mixture 164.

Top closure member 170 includes a slimmed-down nylon grommet 174 received in a metal contoured top washer 176. Grommet 174 receives anode current collector 168 through central aperture 178. Contoured top washer 176 includes an outer annular slot 180 which receives an annular member 182 of grommet 174. Grommet 174 has a corresponding annular slot 184, whereby the combination of slots 180 and 184 define an annular receptacle receiving the top edge region of the cathode assembly 152.

Bottom member 172 includes a contoured metal bottom washer 186 having an annular slot 188, and an outer bottom seal member 190 received in slot 188. Seal member 190 includes a lower leg 192 extending inwardly from the outer region of slot 188 and under the bottom edge of the cathode assembly 152. Seal member 190 can be fabricated from any of a variety of electrically insulating materials. Typical such materials are polymers of the olefin and olefin copolymer classes. Seal member 190 is generally non-compressible in the sense that the density of the seal member generally reflects the unfoamed density of the respective material from which the seal member is fabricated. Upwardly extending outer and inner legs 194 and 196 respectively, on opposing sides of slot 198 are effectively crimped toward each other to provide leak-proof closure of the bottom of the cell. Platform 199 extends across the bottom of the cell 150.

Cell 150 is closed by crimping outer leg 183 of top washer 176 against corresponding outer annular member 182 of grommet 174. The compression of washer 176 against grommet 174 provides a seal that prevents leakage of electrolyte and anode material 164 from the cell 150. It should be noted that cell 150 does not include a cathode can, which traditionally surrounds cathode assembly 152, and includes air ports that delivers ambient air to an air diffuser before the air travels to the catalyst 154 and screen 158 in a similar manner as that described above with reference to button cell 10.

Omitting the cathode can from the design of the can-less cell 150 provides multiple desirable features. First, by incorporating the much lighter-weight top and bottom members 170 and 172 in place of the can, a substantial fraction (e.g. about 25%) of the weight of the cell is eliminated, which enhances the energy/weight ratio of the cell 150. The can-less design thus reduces the weight required for generating a given amount of energy. Second, the can-less embodiment places the cathode assembly 52 openly exposed to the ambient environment, thereby achieving maximum oxygen availability to the cathode. Such free availability of oxygen is advantageous where a high discharge rate is contemplated for the cell. Third, the cost of the cathode can is obviated, including the cost of fabricating the can, including the air ports.

While it is desirable to achieve these advantages, it should be noted that a conventional cathode assembly 52 without a cathode can has significantly less strength than a cathode assembly including a cathode can. Accordingly, conventional screens were made thicker in order to absorb the stresses experienced when the cell 150 is crimped. Thicker cathode assemblies necessarily consume volume that could otherwise be used to occupy active anode material. Advantageously, screen 158 has increased strength compared to conventional screens, and accordingly is capable of absorbing the stress experienced when cell 150 is crimped during fabrication. Screen 158 has a reduced thickness compared to conventional screens, and accordingly the volume of anode material 164 is increased.

Referring now to FIG. 11, cathode assembly 152 of cell 150 is illustrated in accordance with an alternate embodiment. FIG. 11 recognizes that the active carbon catalyst 154 may be applied to the inner surface 162 of screen 158. The rectangular screen is then coated with the active carbon catalyst, which includes a mixture of carbon and PTFE as described above, to form an active cathode layer 153. The rectangular coated screen 158 is then manipulated into an annulus such that catalyst 154 is disposed on the radial inner or outer surface 162. Screen 158 thus defines the outer periphery of the cell 150 illustrated in FIG. 11. Separator 160 is thus installed proximal the radially inner surface 165 of screen catalyst 154. Separator 160 may be fabricated in accordance with any of the embodiments described above with reference to separator 68. The separator 160 divides cathode assembly 152 from an anode 163 containing active anode material 164 that is disposed in the annular void 166 that defined by cathode assembly 152. The anode material may include zinc that is wetted with an aqueous electrolyte, for example potassium hydroxide. A negative current collector 168, which may be a brass pin or nail, extends into void 166 in contact with the anode material 164.

While the present invention has described multiple embodiments of a metal-air cell cathode including a metal-plated screen fabricated in accordance with the present invention, it should be further appreciated that any electrochemical cell cathode undergoing compression during cell fabrication would benefit from the additional strength provided with the plated-screen of the present invention.

The invention has been described in connection with what are presently considered to be the most practical and preferred embodiments. However, the present invention has been presented by way of illustration and is not intended to be limited to the disclosed embodiments. Accordingly, those skilled in the art will realize that the invention is intended to encompass all modifications and alternative arrangements included within the spirit and scope of the invention, as set forth by the appended claims.

1. A cathode assembly for a metal-air cell including an air diffusion layer receiving air and delivering the received air to the cathode assembly, the cathode assembly comprising:
an active layer including longitudinally extending electrically conducting wires interwoven with laterally extending electrically conducting wires that intersect at joints to form a mesh, and metal deposited onto the wires that bonds the longitudinally extending wires to the laterally extending wires at the joints to form a screen.

2. The cathode assembly as recited in claim 1, wherein the metal comprises nickel.

3. The cathode assembly as recited in claim 2, wherein the nickel is electroplated onto the wires.

4. The cathode assembly recited in claim 3 wherein the nickel is deposited by one of electroless deposition, sputter deposition, and chemical deposition.

5. The cathode assembly as recited in claim 2, wherein the nickel forms nodules that protrude outwardly from an outer surface of the wires.

6. The cathode assembly as recited in claim 5, wherein the outer surface deposit comprises columnar grains.

7. The cathode assembly as recited in claim 6, further comprising nodules extending from the surface wherein the nodules are between 10 to 100 μm in diameter.

8. The cathode assembly as recited in claim 5, wherein the outer surface and nodules further comprise grains having diameters between 1 and 30 μm.

9. The cathode assembly as recited in claim 5, wherein the nodules occupy between 5 and 50 percent of a surface area of the nickel.

10. The cathode assembly as recited in claim 1, wherein the wires comprise nickel.

11. The cathode assembly as recited in claim 1, wherein the wires comprise a transition metal.

12. The cathode assembly as recited in claim 1, further comprising a mixture of carbon and PTFE disposed on an outer surface of the screen.

13. A metal-air cell comprising:
a void that is filled with active anode material;
a cathode assembly receiving ambient cathodic air, including:
i. an active carbon catalyst; and
ii. a screen in contact with the catalyst, wherein the screen includes longitudinally extending electrically conducting wires interwoven with laterally extending electrically conducting wires that intersect at joints, and wherein the metal is bonded to the wires at the joints; and
a separator disposed between the cathode assembly and the anode material.

14. The metal-air cell recited in claim 13, wherein the metal comprises nickel.

15. The metal-air cell recited in claim 14, wherein the nickel is electroplated onto the wires.

16. The cathode assembly as recited in claim 5, wherein the outer surface deposit comprises columnar grains.

17. The metal-air cell recited in claim 16, wherein a plurality of nodules extends outwardly from the surface.

18. The metal-air cell as recited in claim 17, wherein the nodules are between 10 and 100 μm in diameter.

19. The metal-air cell as recited in claim 17, wherein the surface and nodules further comprise grains having diameters between 1 and 30 μm.

20. The metal-air cell as recited in claim 17, wherein the nodules occupy between 5 and 50 percent of a surface area of the nickel.

21. The metal-air cell as recited in claim 13, wherein the wires comprise nickel.

22. The metal-air cell as recited in claim 13, wherein the wires comprise a transition metal.

23. The metal-air cell as recited in claim 13, wherein the catalyst further comprises a mixture of carbon and PTFE in contact with the screen.

24. The metal-air cell as recited in claim 13, further comprising a button cell.

25. The metal-air cell as recited in claim 24, further comprising a cathode can surrounding the cathode assembly and defining air ports extending therethrough.

26. The metal-air cell as recited in claim 25, further comprising at least one air diffusion layer disposed between the cathode can and the screen.

27. The metal-air cell as recited in claim 13, further comprising a cylindrical cell.

28. The metal-air cell as recited in claim 27, wherein the screen is disposed between the separator and the carbon catalyst.

29. The metal-air cell as recited in claim 28, wherein the carbon catalyst is disposed between the separator and the screen.

30. A method for fabricating a cathode assembly for use in a metal air cell of the type having an air diffusion layer receiving air and delivering the received air to the cathode assembly, the steps comprising:
(a) providing a mesh having longitudinally extending wires interwoven with laterally extending wires, wherein the wires intersect at joints;
(b) providing an electroplating apparatus including a current source electrically connected to the mesh at one terminal and a mass of metal at another terminal;
(c) immersing the mesh and mass in a salt of the metal to electroplate the wires with the metal at the joints, wherein the electroplated metal bonds the joints together to provide a cathode screen; and
(d) coating the cathode screen with an active cathode catalyst.

31. The method as recited in claim 30, wherein the metal comprises nickel.

32. The method as recited in claim 31, wherein step (c) further produces nodules protruding from outer surfaces of the wires.

33. The method as recited in claim 32, wherein the outer surface grains are columnar.

34. The method as recited in claim 30, wherein the metal salt is selected from the group consisting of nickel chloride, nickel sulfate, nickel sulfamate, and nickel fluoborate.

35. The method as recited in claim 30, wherein the wires comprise nickel.

36. The method as recited in claim 30, wherein the wires comprise a transition metal.

37. The method as recited in claim 30, wherein the active cathode catalyst comprises a mixture of PTFE and carbon.

38. The method as recited in claim 30, further comprising pressure bonding the mesh.

39. A method for producing a metal-air cell, the steps comprising:
(a) providing an anode can defining a void that is filled with active anode material;
(b) providing a cathode can surrounding a portion of the anode can, wherein the cathode can defines air ports extending therethrough;
(c) installing an air diffusing layer into the cathode can;
(d) installing a cathode assembly positioned downstream of the air diffusing layer, the cathode assembly, including:
i. an active carbon catalyst; and
ii. a screen in contact with the catalyst, wherein the screen includes longitudinally extending electrically conducting wires interwoven with laterally extending electrically conducting wires that intersect at joints, and wherein the metal is bonded to the wires at the joints; and
(e) installing a separator between the cathode assembly and the anode.

40. The method as recited in claim 39, further comprising electroplating the metal onto the wires.

41. The method as recited in claim 40, wherein the metal comprises nickel.

42. The method as recited in claim 39, wherein the active carbon catalyst comprises a mixture of carbon and PTFE.

43. The method as recited in claim 39, wherein the wires comprise nickel.

44. The method as recited in claim 39, wherein the wires comprise a transition metal.

45. A method for producing a cylindrical metal-air cell, the steps comprising:
(a) providing a screen having longitudinally extending electrically conducting wires interwoven with laterally extending electrically conducting wires that intersect at joints, and wherein the metal is bonded to the wires at the joints; and
(b) coating the screen with an active carbon catalyst to provide a cathode assembly, wherein the catalyst is positioned to receive ambient air;
(c) winding the cathode assembly into an annulus defining an internal anode void;
(d) installing a separator between the cathode assembly and the void; and
(e) providing an anode material in the void.

46. The method as recited in claim 45, further comprising electroplating the metal onto the wires.

47. The method as recited in claim 45, wherein the metal comprises nickel.

48. The method as recited in claim 45, wherein the active carbon catalyst comprises a mixture of carbon and PTFE.

49. The method as recited in claim 45, wherein the wires comprise nickel.

50. The method as recited in claim 45, wherein the wires comprise a transition metal.

51. The method as recited in claim 45, further comprising coating the active carbon catalyst on an outer surface of the screen.

52. The method as recited in claim 45, further comprising coating the active carbon catalyst on an inner surface of the screen.

53. A method for fabricating an electrochemical cell, comprising:
(a) providing a mesh having longitudinally extending wires interwoven with laterally extending wires, wherein the wires intersect at joints;
(b) pressure-bonding one surface of the mesh to partially bond the wires together at the joints;
(c) providing an electroplating apparatus including a current source electrically connected to the partially bonded mesh at one terminal and a mass of nickel at another terminal;
(d) immersing the partially bonded mesh and mass in a nickel salt to electroplate the wires with nickel at the joints, wherein the electroplated nickel fully bonds the joints together to form a screen;
(e) coating the screen with an active catalyst layer to form a cathode assembly;
(f) providing a void filled with an anode material; and
(g) installing a separator between the cathode assembly and the anode material.

54. The method as recited in claim 53, wherein step (d) further produces nodules protruding from outer surfaces of the wires.

55. The method as recited in claim 54, wherein the outer surface grains are columnar.

56. The method as recited in claim 53, wherein the metal salt is selected from the group consisting of nickel chloride, nickel sulfate, nickel sulfamate, and nickel fluoborate.

57. The method as recited in claim 53, wherein the wires comprise nickel.

58. The method as recited in claim 53, wherein the wires comprise a transition metal.

59. The method as recited in claim 53, wherein the catalyst comprises a mixture of PTFE and carbon.

60. A method for fabricating an electrochemical cell disposed in a container, the steps comprising:
(a) providing a mesh having longitudinally extending wires interwoven with laterally extending wires intersecting at joints;
(b) plating a metal onto the wires to bond the joints together;
(c) coating the screen with an active catalyst layer to form a cathode assembly;
(d) providing a void filled with an anode material;
(e) installing a separator between the cathode assembly and the anode material; and
(f) closing the container, thereby compressing the cathode assembly against the container to form a seal preventing electrolyte leakage from the cell.

61. The method as recited in claim 60, wherein step (b) further comprises:
i. providing an electroplating apparatus including a current source electrically connected to the mesh at one terminal and a mass of metal at another terminal; and
ii. immersing the partially bonded mesh and mass in a salt to electroplate the wires with the metal at the joints, wherein the electroplated metal fully bonds the joints together to form a screen.

62. The method as recited in claim 61, wherein the metal comprises nickel.

63. A method for producing a metal-air cell, the steps comprising:
(a) providing an anode can defining a void that is filled with active anode material;
(b) providing a cathode can surrounding a portion of the anode can, wherein the cathode can defines air ports extending therethrough;
(c) installing a cathode assembly positioned downstream of the air diffusing layer, the cathode assembly, including:
i. an active carbon catalyst;
ii. a screen in contact with the catalyst, wherein the screen includes longitudinally extending electrically conducting wires interwoven with laterally extending electrically conducting wires that intersect at joints, and wherein the metal is bonded to the wires at the joints; and
iii. a diffusion layer coated onto the active carbon catalyst; and
(d) installing a separator between the cathode assembly and the anode.
